(19) United States
(12) Patent Application Publication
(10) Pub. No.: US 2015/0177597 A1
(43) Pub. Date: Jun. 25, 2015

(54) Temporary Adhesive Camera Mount

(71) Applicant: GoPro, Inc., San Mateo, CA (US)

(72) Inventors: Ryan Harrison, El Granada, CA (US); Joshua Todd Druker, Redwood City, CA (US)

(21) Appl. No.: 14/578,292

(22) Filed: Dec. 19, 2014

Related U.S. Application Data
(60) Provisional application No. 61/919,594, filed on Dec. 20, 2013.

(51) Int. Cl. G03B 17/56

(52) U.S. Cl. CPC G03B 17/561

(57) ABSTRACT

A removable adhesive base mount is structured to couple a camera mount system to a capture surface such as a sports board, a helmet, a vehicle, and the like. An upper camera mount component securing a camera couples to a lower camera mount component, which in turn couples to the removable adhesive base mount. The removable adhesive mount includes a base mount component, a foam component, a separating component and an adhesive component. Stretching the adhesive component decouples the adhesive component from the capture surface and the separating component thereby decoupling the removable adhesive base mount from the capture surface.

### CROSS REFERENCE TO RELATED APPLICATIONS

This application claims the benefit of U.S. Provisional Application No. 61/919,594, filed Dec. 20, 2013, which is incorporated by reference in its entirety.

### BACKGROUND

1. Technical Field

This disclosure relates to camera mounts, and more specifically, to an adhesive removable camera mount.

2. Description of the Related Arts

A variety of different camera mounts are available for mounting cameras to different types of objects. Adhesive-based camera mounts are particularly versatile because they can be used to mount a camera to a flat surface. However, conventional adhesive mounts are often inconvenient because they are difficult to remove once affixed to a surface and may cause damage to the surface or the mount itself if removal is attempted.

### BRIEF DESCRIPTIONS OF THE DRAWINGS

The disclosed embodiments have other advantages and features which will be more readily apparent from the following detailed description of the invention and the appended claims, when taken in conjunction with the accompanying drawings, in which:

FIG. 1 illustrates a removable adhesive base mount system, according to one embodiment.

FIG. 2 illustrates an exemplary use of a removable adhesive base mount system, according to one embodiment.

FIG. 3a illustrates a lower mount component and a base mount component uncoupled from each other, according to one embodiment.

FIG. 3b illustrates a lower mount component coupled to a base mount component, according to one embodiment.

FIG. 4 illustrates a camera housing coupled to lower mount component, according to one embodiment.

### DETAILED DESCRIPTION

The figures and the following description relate to preferred embodiments by way of illustration only. It should be noted that from the following discussion, alternative embodiments of the structures disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system for purposes of illustration only. One skilled in the art will readily recognize from the following description that alternative embodiments of the structures illustrated herein may be employed without departing from the principles described herein.

### OVERVIEW

A camera mount system includes a lower mount component and a removable adhesive base mount. The lower mount component couples to the removable adhesive base mount and the removable adhesive base mount couples to a mounting surface. The mounting surface can comprise, for example, a surface of a sports board, a helmet, a chest mount, a vehicle, and the like. The removable adhesive base mount can include a base mount component, a foam component, a separating component and an adhesive component. The combination of the base mount component, the foam component, the separating component and the adhesive component couples the removable adhesive base mount component to the capture surface temporarily, such that the base mount system, and thus the camera housing may be removed and coupled to another surface if desired. Furthermore, the capture surface is not restricted to being a flat surface, but may have varying textures and curvatures.

The adhesive component can comprise a stretch release adhesive material. The adhesive component is coupled to the mounting surface by pressing the adhesive component on the mounting surface. When the adhesive component is stretched the adhesive force between the adhesive component and the mounting surface is weakened, thereby breaking the adhesive bond to the mounting surface and enabling the easy removal of the removable adhesive base mount from the mounting surface.

### SYSTEM CONFIGURATION

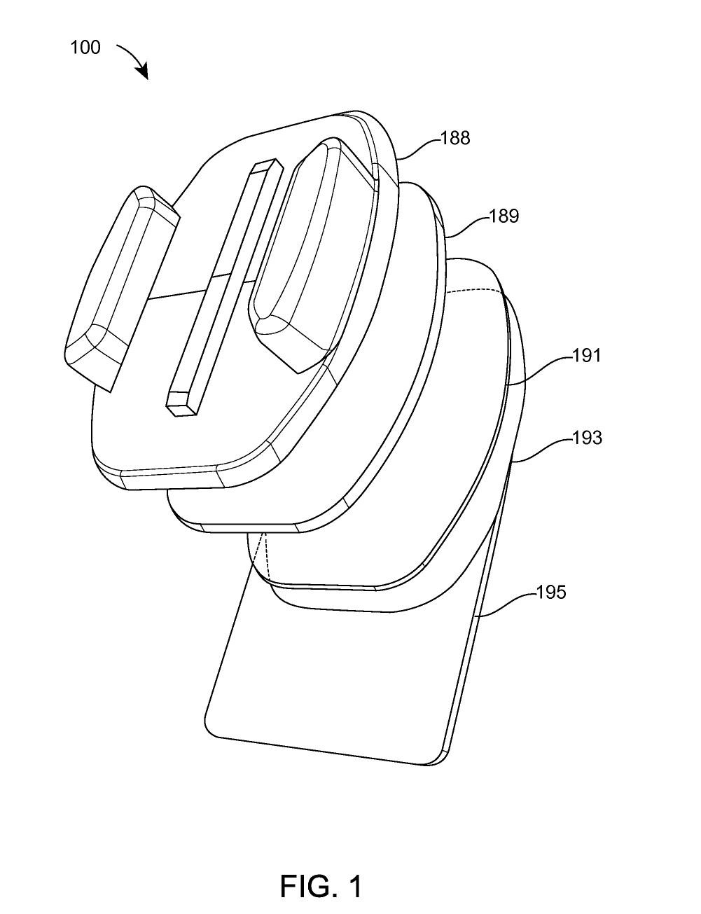

FIG. 1 illustrates an exploded view of a removable adhesive base mount 100 for a camera mount system according to one embodiment. The removable adhesive base mount 100 includes a base mount component 188, a foam component 189 (e.g., a foam layer), a separating component 191 (e.g., a separating layer) and an adhesive component 193 (e.g., an adhesive layer) having a pull tab 195. In alternative embodiments, additional components may be included.

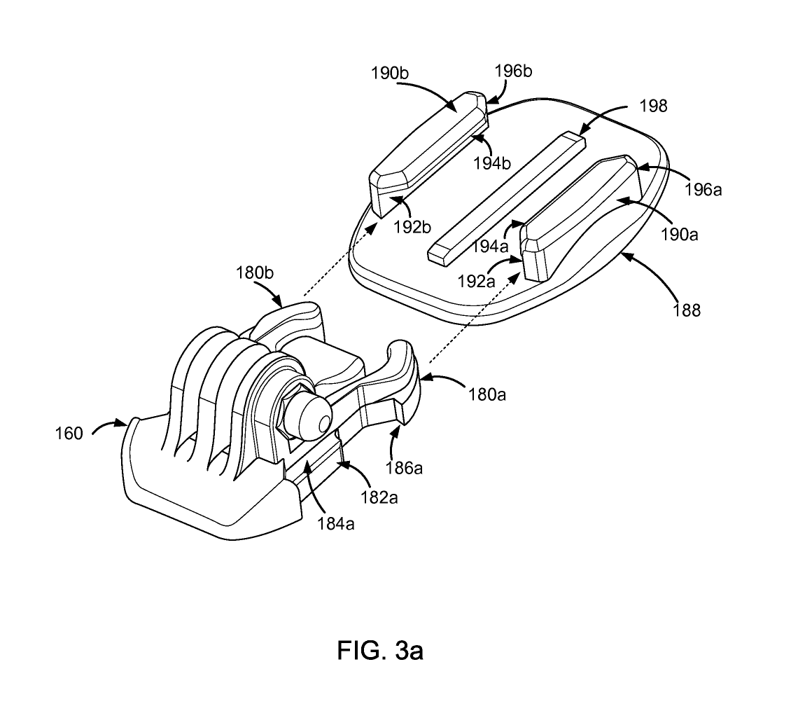

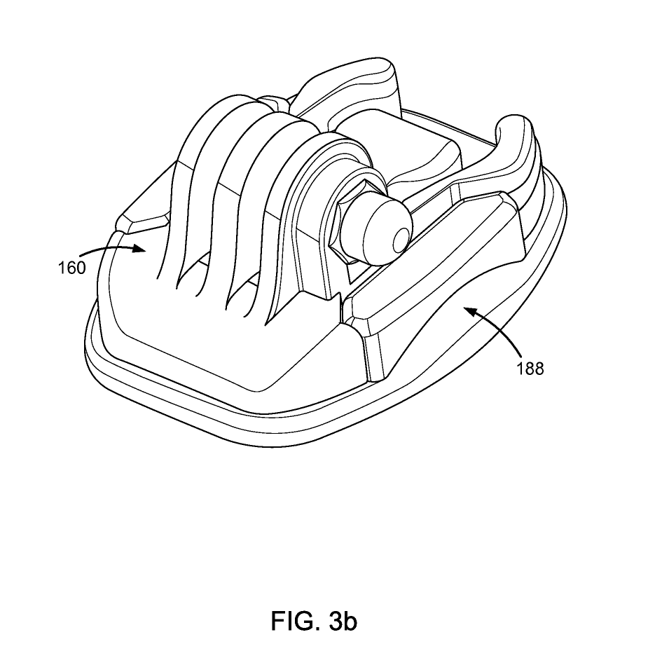

The base mount component 188 comprises a substantially rigid material such as plastic. A first (e.g., upper) surface of the base mount component 188 comprises one or more securing structures for coupling to a reciprocal portion of a camera mount system as discussed in greater detail with respect to FIG. 3. A second (e.g., lower) surface of the base component 188 comprises a substantially flat surface for adhering to an upper surface of the foam component 189 discussed below. In an alternative embodiment, another suitable mounting means may be used that does not necessarily have the structure of the base mount component 188 illustrated herein.

The foam component 189 is layered between a bottom surface of the base mount component 188 and the separating component 191. In one embodiment, the foam component 189 substantially covers the bottom surface of the base mount component 188, although in an alternative embodiment, the foam component 189 may cover only a portion of the bottom surface of the base mount component 188. The foam component may be made of one or more of the following materials or types of foam known in the art, polyurethane, high density foam, evlon, high resilience foam, latex rubber foam, rebond, memory foam, closed cell foam, dry fast foam or adhesive foam tape. The foam component 189 may be coupled to the base mount component 188 by using a strong adhesive designed to avoid separation of the foam component 189 from the base mount component 188 during normal use. Alternatively, the foam component 189 may be made of adhesive foam tape, such that the adhesive properties of the adhesive foam tape couple the foam component 189 to the base mount component 188 on one side and the separating component 191 on the other side. In one embodiment, the foam component 189 is in the range of approximately 0.5 millimeters-2.5 millimeters in thickness. The foam component 189 generally acts to absorb vibrations, thereby increasing the load-bearing capability of the removable adhesive base mount 100. In an alternative embodiment, another suitable vibration absorbing means may be used instead of foam.

The separating component 191 is layered between the foam component 189 and the adhesive component 193 such that the separating component substantially covers the bottom surface of the foam component 189. The separating component 191 is coupled to the foam component 189 and the adhesive component 193 using adhesives. The adhesive between the separating component 191 and the foam component 189 is generally designed to prevent separation of the two components during normal use. However, the separating component 191 and adhesive component 193 are adhered in a manner that enables separation through the stretch release properties of the adhesive component 193 described below. Thus the separating component 191 also protects the foam component 189 from damage that may occur on the removal of the adhesive component 193. In one embodiment, the separating component 191 comprises one or more kinds of plastic. For example, in one embodiment, the separating component 191 is made of polyethylene terphthalate (PET), polycarbonate, aluminum foil or mylar, and may be rigid or semi-rigid in constitution. PET is a desirable material for the separating component 191, in one embodiment, as it is relatively durable, and has a relatively high surface energy thereby allowing the separating component 191 to bond well to both the foam component 189 and adhesive component 193. In another embodiment, another suitable separating means may be used that may comprise a different material or physical properties than that described herein. The separating component 191 can have a thickness ranging from 0.05 millimeters-0.3 millimeters in one embodiment. A separating component 191 that is too thin may result in the foam component 189 being damaged on the separation of the adhesive component 193 from the separating component 191. A separating component 191 that is too thick may reduce the conformability of the mount to a variety of surfaces.

The adhesive component 193 is coupled to the bottom side of the separating component 191 and is configured to be mounted to the mounting surface. In one embodiment, the adhesive component 193 comprises a stretch release adhesive material. When the adhesive component 193 is pressed against the mounting surface, an adhesive force acts to adhere the adhesive component 193 to the mounting surface, thus adhering the removable adhesive base mount 100 to the mounting surface. The adhesive force between the adhesive component 193 and the mounting surface is substantially weakened when the adhesive component 193 is stretched along the plane parallel to the mounting surface due to the material properties of the adhesive component 193. Thus, stretching the adhesive component 193 in a direction substantially parallel to the mounting surface breaks the adhesive bond between the bottom surface of the adhesive component 193 and the mounting surface and enables the removable adhesive base mount 100 to be easily removed from the mounting surface. Stretching of the adhesive component 193 also weakens the adhesive bond between the top surface of the adhesive component 193 and the bottom surface of the separating component 191, thus enabling the separating component 191, foam component 189, and mounting component 188 to collectively detach from the adhesive component 193. The separating component 191, foam component 189, and mounting component 188 remain affixed to each other and can therefore be re-used by replacing the adhesive component 193. In one embodiment, the adhesive component 193 has a thickness ranging from approximately 0.1 millimeters to 0.7 millimeters. The adhesive component 193 may have a thickness such as 1 millimeter or a value greater than 1 millimeter. In another embodiment, another suitable releasable adhesive means may be used that may comprise a different material or physical properties than that described herein.

In one embodiment, a pull tab 195 of the adhesive component 193 extends from the adhesive component 193 along the plane parallel to the face of the adhesive component 193. The pull tab 195 is coated with a non-adhesive material on its exterior surface so that the pull tab 195 does not adhere to the mounting surface. For example, in one embodiment, the pull tab 195 comprises a PET material. The pull tab 195 is structured such that it enables the user to easily grab and pull the pull tab 195 to stretch and release the adhesive component 193. For example, the pull tab 195 may be approximately the same width as the adhesive component 193 to enable the user to easily grab and pull the pull tab 195 to stretch and release the adhesive component 193 and ensure that the adhesive component 193 stretches and releases properly.

Once the adhesive component 193 has been stretched and released from a mounting surface and the separating component 191, it can be replaced with a new adhesive component 193 so that the user can re-use the removable adhesive base mount 100 without replacing any other components. For example, the new adhesive component 193 is adhered on one side to the separating component 191 and adhered on the side to a mounting surface when the user is ready to re-use the mount 100.

In one embodiment, a plastic liner (not shown) can be used to protect the adhesive faces of the adhesive component 193 prior to adhering the adhesive component to the separating component 191 or to the mounting surface. The plastic liner allows the adhesive component 193 to retain its adhesive properties prior to being coupled with a mounting surface or to the separating component 191. The plastic liner comprises a material that can be easily removed from the adhesive surface of the adhesive component 193 prior to coupling the adhesive component 193 to the mounting surface.

Traditional stretch release adhesives (such as the 3M COMMAND poster adhesive or the 3M adhesive foam tape) are conventionally used as poster mounts to mount posters, frames or hooks on walls. However traditional stretch release adhesives or adhesive foam tapes have fairly limiting load bearing characteristics, and when attached directly to a hard plastic component such as base mount component 188 (without the foam component 189 and separating component 191 in between)are not dense enough, and thus would not be suitable for mounting a camera to a variety of surfaces. With respect to the adhesive foam tapes, wherein a thin layer of foam is sandwiched between 2 stretch release adhesives, the stretchable foam does not have the load bearing characteristics to prevent the rocking of the base mount component 188 if attached directly to base mount component 188 (without the foam component 189 and separating component 191 in between), thereby leading to an unsteady video recording or photograph.

The combination of the base mount component 188, the foam component 189, the separation component 191, and the adhesive component 193 allow for the base mount system 100 to be removably adhered to smooth or irregular mounting surfaces while providing the load bearing characteristics that beneficially allow the camera to capture stable still images or videos. The foam component 189 adds a flexible layer between the substantially inflexible base mount component 188 and the mounting surface. The foam component 189 is flexible and can be compressed along different regions of the foam component 189, thus enabling the base mount system 100 to be coupled to a mounting surface with irregularities such as curves, varying textures, or in some cases fragile mounting surfaces.

The stretch characteristics of the foam component 189 also yield higher peel strength, reducing the risk of the base mount component 188 decoupling from the separating component 191 and the adhesive component 193 while the user is using the camera mount, and further adding to the adhesion of the base mount component 188 to the mounting surface. The foam component furthermore 188 pads and protects the mounting surface from being dented if the camera mount moves back and forth by absorbing some of the impact energy. Further, the foam component 188 absorbs vibrations from the mounting surface and thus reduces the effect of these vibrations on the camera or camera housing, thereby enabling the camera to capture more stable still images and/or video.

The separating component 191 protects the foam from possible damages that may be caused as a result of the foam component 189 interacting with the adhesive component 193. The separating component 191 also acts as a suitable surface for the adhesive component 193 to bond to and release from.

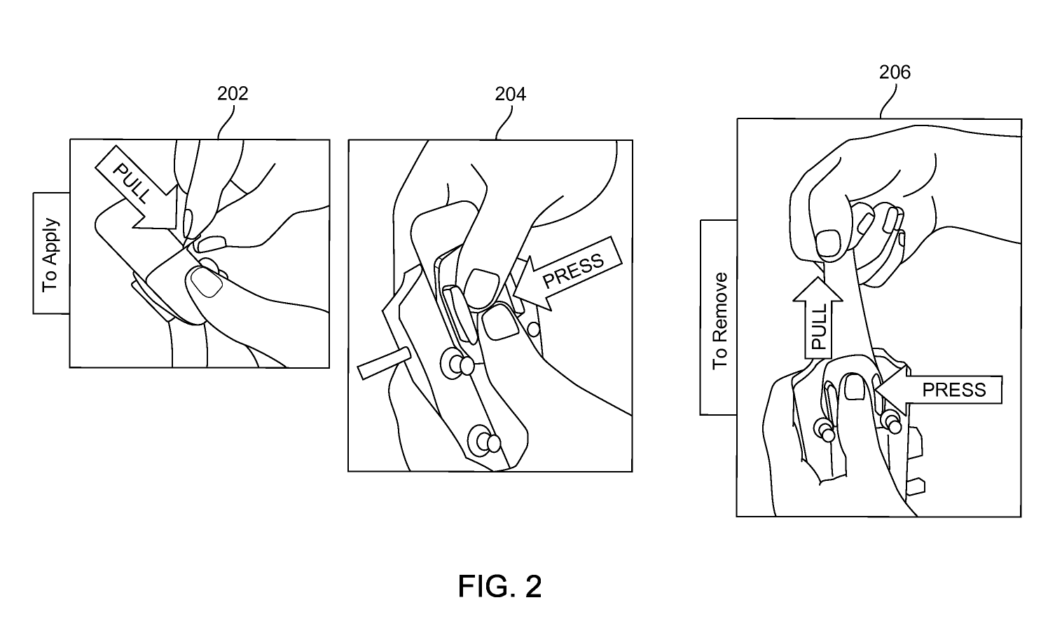

FIG. 2 illustrates an exemplary use of the base mount system, according to one embodiment. A user first removes 202 the plastic liner, exposing the adhesive surface of the adhesive component 193. After aligning the base mount system 100 on the mounting surface, with the exposed face of the adhesive component 193 facing the mounting surface, the user then places 204 the base mount system 100 on the capture surface and gently presses 204 the base mount system 100 on to the mounting surface. This causes the adhesive component 193 to adhesively bond to the mounting surface. The user may then couple the camera system to the base mount 100 as described below in conjunction with FIG. 3.

To decouple 206 the base mount system 100 from the capture surface the user presses down on the base mount system 100 and pulls the pull tab 195. Pulling the pull tab 195 stretches the adhesive component 193 along the axis parallel to the surface of the adhesive component 193. Based on the material properties of the adhesive component 193, the stretching action weakens the adhesive bond between the adhesive component 193 and the mounting surface and between the adhesive component 193 and the separating component 191. The weakened bond causes the adhesive component 193 to physically decouple 206 from the mounting surface and the separating component 191. The separating component 191, foam component 189, and base mount component 188 remain affixed to each other and may therefore be re-used with a new adhesive component 193.

FIGS. 3a and 3b illustrate an example embodiment of a lower mount component 160 of a mounting system and a base mount component 188 of the mounting system, according to one embodiment. The lower mount component 160 includes two prongs 180a and 180b that can be flexibly compressed inward when squeezed. The prongs 180a and 180b include side securing surfaces 182a and 182b (not shown), top securing surfaces 184a and 184b (not shown), and securing lips 186a and 186b (not shown), respectively. The base mount component 188 includes securing arms 190a and 190b, each with side securing surfaces 192a and 192b, top securing surfaces 194a and 194b, and back securing surfaces 196a and 196b, respectively. The base mount component 188 additionally includes a spine 198 comprising a protrusion along a longitudinal axis of the base mount component 188.

When the prongs 180a and 180b of the lower mount component 160 are squeezed together, the width of the prong-side of the lower mount component is reduced to less than the width between the securing arms 190a and 190b, such that the lower mount component can be slid onto the base mount component 188. When the lower mount component is slid onto the base mount component 188, the side securing surfaces 182a and 182b make contact with and slide along the side securing surfaces 192a and 192b, respectively. Similarly, the top securing surfaces 184a and 184b make contact with and slide along the top securing surfaces 194a and 194b, respectively. When the lower mount component 160 is completely slid into the base mount component 188, the securing arms decompress outward when the securing lips 186a and 186b are slid past the back securing surfaces 196a and 196b. The securing arms 190a and 190b flexibly exert force outward such that the securing lips 186a and 186b extend outwards and make contact with the back securing surfaces 196a and 196b or overlap at least partially with the back securing surfaces 196a and 196b, preventing the lower mount component 160 from sliding backwards and securely coupling the lower mount component 160 to the base mount component 188 as illustrated in FIG. 3b. The lower mount component 160 can be uncoupled from the base mount component 188 by compressing the securing arms of the lower mount 160 component such that the width of the prong-side of the lower mount component 160 is again reduced to less than the width between the securing arms 190a and 190b of the base mount component 188, and sliding the lower mount component 160 backwards past the base mount component 188.

The lower mount component 160 can include a spine groove on the bottom side of the lower mount component 160 to allow for the reciprocal sliding and insertion of the spine 198 of the base mount component 188 into the spine groove when the lower mount component 160 is slid onto and secured to the base mount component 188.

It should be noted in alternative embodiments, the lower mount component 160 is configured to securely couple to the base mount component 188 using other means than those described with regards to FIGS. 3a and 3b. For example, the lower mount component 160 can include a securing protrusion on the bottom side of the lower mount component 160 configured for insertion into a reciprocal opening within the base mount component 188, and secured using, for example, a securing pin or other locking mechanism. Similarly, the securing arms 190a and 190b of the base mount component 188 can be compressible or flexible such that the arms can be squeezed apart, the lower mount component 160 can be slid onto the base mount component 188, and the arms can be released, securely coupling the lower mount component 160 to the base mount component 188. The lower mount component 160 can be securely coupled to the base mount component 188 using adhesives, buttons, ties, latches, springs, or any combination of the mechanisms described herein. Any other suitable securing mechanism can be used to secure the lower mount component 160 to the base mount component 188.

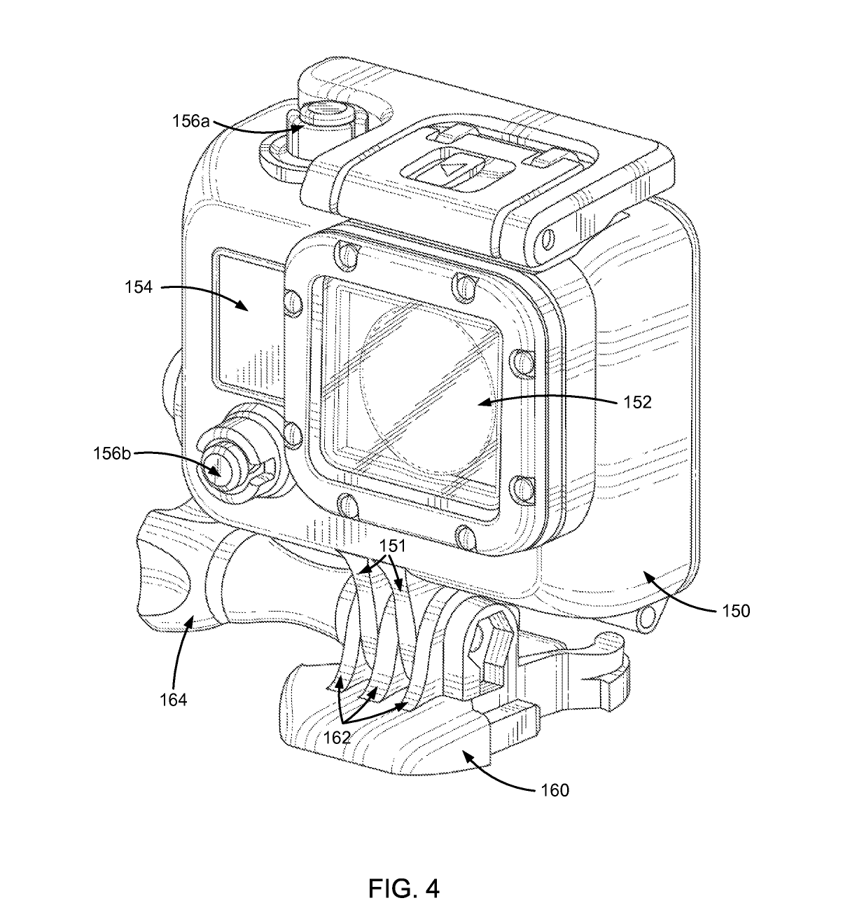

FIG. 4 illustrates a camera housing coupled to lower mount component, according to one embodiment. The camera housing 150, also referred to herein as the upper mount component, is configured to enclose a camera. The camera housing 150 can be rigid (or substantially rigid) (e.g., plastic, metal, fiberglass, etc.) or pliable (or substantially pliable) (e.g., leather, vinyl, neoprene, etc.). The camera housing 150 of FIG. 4 includes a front face and four sides (i.e. a top side, bottom side, left side, and right side) structured to form a cavity that receives a camera. The camera housing 150 also includes a housing door (not shown in FIG. 3) that detachably couples to the four sides opposite the front face to form a back face of the camera housing, thereby enclosing a camera inserted into the housing cavity when the door is coupled to the four sides and is in a closed position. In one embodiment, when the housing door is in a closed position, the housing creates a waterproof seal around the camera enclosed within the housing.

The camera housing 150 includes a lens 152. In one embodiment, when a camera (not shown) is enclosed within the camera housing of FIG. 4, the lens of the camera aligns with the lens 152 of the housing. The camera housing 150 also includes a lens 154 and buttons 156a and 156b that can align with the display and buttons of the camera, when the camera is enclosed within the camera housing 150 of FIG. 4.

The camera housing 150 includes two protrusions 151 on the bottom surface of the camera housing 150, and the lower mount component 160 includes three protrusions 162 on the top surface of the lower mount component 160. In one embodiment, each of the two protrusions 151 and the three protrusions 162 include a hole of similar diameter such that when the two protrusions 151 of the camera housing are inserted into the spaces between the three protrusions 162, the holes can substantially align. When the holes are substantially aligned, the handscrew 164 can be inserted through the holes, thereby coupling the camera housing 150 to the lower mount component 160. The housing 150 can pivot around the lower mount component 160 when the handscrew 164 is in a first position, and can be fixedly coupled to the lower mount component 160 when the handscrew 164 is in a second position. It should be noted that a pin or any other mechanism configured for coupling the camera housing 150 and the lower mount component 160 can be used in place of a turnable handscrew 164.

It should be noted that in other embodiments, upper mount components other than the camera housing 150 of FIG. 4 can be used to secure a camera. In one embodiment, an upper mount component is configured to securely couple to a camera without necessarily enclosing the camera. In these embodiments, the upper mount component may enclose only a portion of the camera, leaving other portions of the camera exposed. For example, an upper mount component may secure around the bottom, top, and side surfaces of a camera, exposing the front and the back surface of the camera. In other embodiments, an upper mount component may couple to only a bottom surface of the camera, for instance using an adhesive, a releasable latch, Velcro, or any other securing mechanism.

### ADDITIONAL CONFIGURATION CONSIDERATIONS

It is noted that some embodiments described herein have used the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs for a vibration dampener component as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A camera mount system comprising:
a base mount component having a bottom surface and an upper surface comprising one or more securing structures for securing to a lower mount component having a reciprocal securing structure;
a foam component layered below the bottom surface of the base mount component, the foam component comprising a top surface coupled to the base mount component and a bottom surface;
a separating component layered below the bottom surface of the foam component, the separating component comprising a top surface coupled to the foam component and a substantially flat bottom surface; and
an adhesive component adhering to a bottom surface of the separating component, the adhesive component having a bottom surface configured to adhere to a mounting surface, and the adhesive component comprising a stretch release material that releases an adhesive bond between the adhesive component and the mounting surface and between the adhesive component and the separating component when the adhesive component is stretched in a direction substantially parallel to a face of the adhesive component.

2. The camera mount system of claim 1, wherein the foam component, the separating component and the base mount component remain fixed together when the adhesive component is stretched.

3. The camera mount system of claim 1, further comprising a pull tab extending from the adhesive component along the plane parallel to an adhesive surface of the adhesive component.

4. The camera mount system of claim 1, wherein the foam component comprises a thickness in the range of approximately 0.5 millimeters-4 millimeters.

5. The camera mount system of claim 4, wherein the foam component is comprised of at least one of the following materials: adhesive foam tape, rubber, thermoplastic elastomers, polyurethane, high density foam, and memory foam.

6. The camera mount system of claim 1, wherein the separating component is of thickness ranging from 0.05 millimeters-0.3 millimeters.

7. The camera mount system of claim 6, wherein the separating component is comprised of at least one of the following materials: polyethylene terphthalate, polycarbonate, aluminum foil and mylar.

8. The camera mount system of claim 1, wherein the adhesive component is of thickness ranging from 0.1 millimeters-0.7 millimeters.

9. The camera mount system of claim 1, wherein the lower mount component comprises:
first and second compressible prongs, each compressible prong comprising a first securing surface and a securing lip.

10. The camera mount system of claim 9, wherein the lower mount component is configured to couple to the base mount component when the first and second compressible prongs are compressed, the lower mount component is slid onto the base mount component, and the compressible prongs are decompressed such that securing lip of each prong overlaps at least in part with the one or more securing structures of the base mount component.

11. The camera mount system of claim 10, wherein the base mount component further comprises a spine.

12. The camera mount system of claim 10, wherein a top surface of the lower mount component is configured to couple to an upper mount component.

13. The camera mount system of claim 12, wherein the upper mount component configured to enclose a camera, the upper mount component comprising a first plurality of protrusions, each of the first plurality of protrusions comprising a hole within the protrusion of a first size.

14. The camera mount system of claim 13, wherein the lower mount component further comprises a second plurality of protrusions, each of the second plurality of protrusions comprising a hole within the protrusion of the first size, wherein the first plurality of protrusions are interlocked with the second plurality of protrusions such that holes of the first and second pluralities of protrusions are aligned.

15. The camera mount system of claim 14, further comprising a pin inserted into the aligned holes of the first and second pluralities of protrusions, thereby coupling the upper mount component to the lower mount component.

16. The camera mount system of claim 1, wherein the adhesive component is configured to couple to one or more of the following: a user, a helmet, a vehicle, a sports board, a piece of sporting equipment, or a surface.

17. The camera mount system of claim 1, wherein the bottom surface of the base mount component, the top and bottom surfaces of the foam component, and the top and bottom surfaces of the separating component are each substantially flat.

18. A camera mount system comprising:
a mounting means for attaching to a mounting component of a lower mount component having a reciprocal securing structure;
a removable adhering means for adhering to a mounting surface, the removable adhering means configured to release an adhesive bond to the mounting means when stretched;
a vibration absorbing means for absorbing vibrations experienced by the camera mount system, the vibration absorbing means disposed between the mounting means and the removable adhering means; and
a separating means for separating the vibration absorbing means from the removable adhering means, the separating means disposed between the vibration absorbing means and the removable adhering means.

19. The camera mount system of claim 18, further comprising a pulling means extending from the removable adhering means, the pulling means for stretching the removable adhering means.

20. A camera mount system comprising:
a base mount component having a bottom surface and an upper surface comprising a spine and first and second securing arms, the spine comprising a protrusion from the upper surface along a longitudinal axis of the upper surface, and the first and second securing arms on a left side and right side of the spine respectively, the first and second securing arms to secure to a lower mount component having a reciprocal securing structure;
a foam component layered below the bottom surface of the base mount component, the foam component comprising a top surface coupled to the base mount component and a bottom surface; and
a separating component layered below the bottom surface of the foam component, the separating component comprising a top surface coupled to the foam component.
